(19) United States
(12) Patent Application Publication
(10) Pub. No.: US 2006/0193595 A1
(43) Pub. Date: Aug. 31, 2006

(54) Organizer

(76) Inventor: Eric Paul Merritt, Lehi, UT (US)

Correspondence Address: Eric Paul Merritt, 202 East 2700 North, Lehi, UT, 84043, US

(21) Appl. No.: 11/347,812

(22) Filed: Feb. 3, 2006

Related U.S. Application Data
(60) Provisional application No. 60/650,168, filed on Feb. 4, 2005.

(51) Int. Cl. G02B 6/00

(52) U.S. Cl. 385/147

(57) ABSTRACT

A system for organizing items, comprising: a container for organizing items; and a tag holder on the container, the tag holder capable of holding a label that is visible from the inside and the outside of the container when the container is open, and visible from the outside of the container when the container is closed.

This application claims priority to provisional application 60/650,168, filed Feb. 4, 2005. This provisional application is herein incorporated by reference.

### BRIEF DESCRIPTION OF THE DRAWINGS

FIG. 1 illustrates a top view of an organizer, according to one embodiment of the invention.

FIG. 2 illustrates a side view of the organizer, according to one embodiment of the invention.

FIG. 3 illustrates a close-up view of the organizer, according to one embodiment of the invention.

### DETAILED DESCRIPTION OF EMBODIMENTS OF THE INVENTION

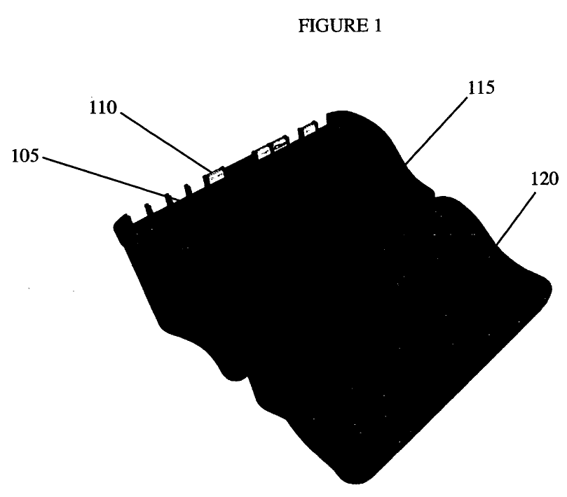

FIG. 1 illustrates an organizer that can be used for multiple purposes. The organizer will be described in the form of a toy or game organizer, but the organizer is not limited to organizing games and/or toys, and can be used to organize anything (e.g. puzzles, scrapbooking tools and supplies, needlework tools and supplies, various hardware supplies, backpack contents, etc.).

In one embodiment, the organizer will neatly and attractively organize games. The organizer is easy to move, store and use. The organizer concept and design are extremely simple and yet thoroughly thought out. Read below about its design and construction.

FIG. 1 illustrates how small pieces, such as game pieces, can be put inside small cinch bags 105 that rest in the organizer, for example, at the front of the organizer. The bags can be held upright, untangled and closed by their cords hanging from a hanging device 110 from the top of the organizer.

In one embodiment, the bag material can be silky so they won't bind with other bags when they are being put in and out of the case. Multiple other materials may also be used.

In one embodiment, other items, such as game boards 115 can stand upright in the back half of the case much like paper in a file folder and are easy to see and access, even for small children. The boards can also be folded.

In one embodiment, the top 120 (when open) can be used as a place to organize or hold items in the organizer, such as to roll dice or organize game pieces (i.e. monopoly money).

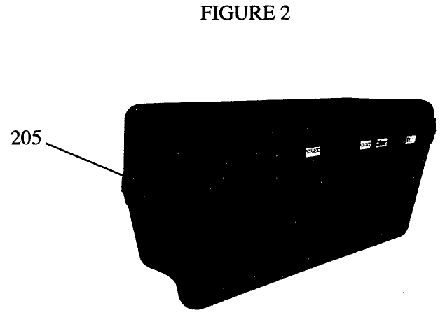

FIG. 2 illustrates a side view of the organizer. In one embodiment, the organizer handles 205 can be formed by the indented “swoop” of the top and bottom. Those of skill in the art will see that multiple other type of handles are possible.

In one embodiment, the case can be made of polypropylene plastic which makes it durable and not brittle. Multiple other materials may also be used.

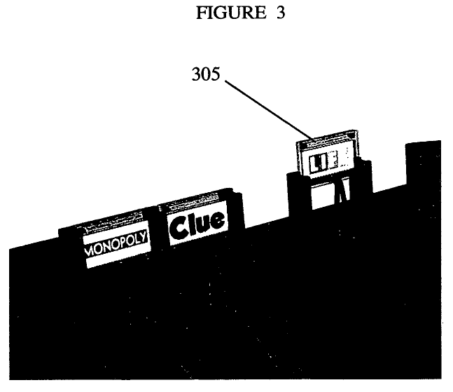

FIG. 3 illustrates a close-up view of the organizer. In one embodiment, the bag cords can be attached to the case by a tag 305 that holds a label. The labels can be used to identify the game pieces inside the bag. The bag cords can be attached to the organizer in any manner. In one embodiment the tags can be made of clear plastic. In one embodiment the labels can be made of paper and printed on both sides.

FIG. 3 illustrates how the labeled tag can be seen clearly from the front when the box is closed and when the box is open, it can be seen from both sides.

In one embodiment, the organizer is divided into two compartments. For example, when holding games, one compartment can be used for the game boards and one compartment for the game pieces. The organizer can also have one or multiple compartments for any variety of uses.

The game organizer can be any color or multiple colors.

While various embodiments of the present invention have been described, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relative art(s) how to implement the invention in alternative embodiments. Thus, the present invention should not be limited by any of the above described exemplary embodiments.

In addition, it should be understood that the figures, which highlight the functionality and advantages of the present invention, are presented for example purposes only. The architecture of the present invention is sufficiently flexible such that it may be utilized in ways other than that shown in the accompanying figures.

1. A system for organizing items, comprising:
a container for organizing items; and
a tag holder on the container, the tag holder capable of holding a label that is visible from the inside and the outside of the container when the container is open, and visible from the outside of the container when the container is closed.

2. The system of claim 1, further comprising:
a bag that hangs near the tag holders.

3. The system of claim 2, wherein the bag is capable of being hung in an upright, untangled, and closed manner by a cord tethering the bag to the top of the organizer.

4. The system of claim 2, wherein the bag material can be such that it doesn't bind with another bag being stored in the container.

5. The system of claim 1, wherein the organizer is divided into at least two compartments.
